(19) United States
(12) Patent Application Publication
(10) Pub. No.: US 2023/0352748 A1
(43) Pub. Date: Nov. 2, 2023

(54) NEGATIVE ELECTRODE ACTIVE MATERIAL FOR AQUEOUS POTASSIUM ION BATTERY AND AQUEOUS POTASSIUM ION SECONDARY BATTERY

(71) Applicant: TOYOTA JIDOSHA KABUSHIKI KAISHA, Toyota-shi (JP)

(72) Inventors: Hiroshi Suyama, Mishima-shi (JP); Shigeki Sato, Fujinomiya-shi (JP)

(21) Appl. No.: 18/304,405

(22) Filed: Apr. 21, 2023

(30) Foreign Application Priority Data
Apr. 28, 2022 (JP) 2022-075032

(51) Int. Cl. H01M 10/26; H01M 4/485

(52) U.S. Cl. CPC H01M 10/26; H01M 4/485; H01M 2004/027

(57) ABSTRACT

The present disclosure provides a novel negative electrode active material for a potassium ion secondary battery and a novel configuration of a potassium ion secondary battery. The negative electrode active material for an aqueous potassium ion battery of the present disclosure comprising tungsten oxide and/or consisting of tungsten oxide. The aqueous potassium ion battery of the present disclosure comprises tungsten oxide as a negative electrode active material. The aqueous potassium ion battery of the present disclosure may comprise an aqueous electrolytic solution, a pH of the aqueous electrolytic solution is 4.0 to 12.0, and the aqueous electrolytic solution may comprise a solvent comprising water and potassium pyrophosphate dissolved in the solvent.

### FIELD

The present disclosure relates to a negative electrode active material for an aqueous potassium ion battery and an aqueous potassium ion secondary battery.

### BACKGROUND

Patent Literature 1 discloses an aqueous electrolytic solution comprising water and potassium pyrophosphate dissolved in water as an electrolytic solution used in an aqueous potassium ion battery.

Non-Patent Document 1 discloses that a full cell operation of about 1.0V can be performed using KₓFe_{y}Mn_{1-y}[Fe(CN)₆]_{w} zH₂O as a cathode, 3,49,10-perylene tetracarboxyl diimide node as an anode, and 22 mol/L KCF₃SO₃ as a water-in-salt electrolyte.

### CITATION LIST

### Patent Literature

[PTL 1] JP 2019-220294 JP

### Non-Patent Document

[NPLT 1] NATURE Energy, “Building aqueous K-ion batteries for energy storage”, May 13, 2019, vol. 4, p. 495-503

### SUMMARY

### Technical Problem

In commercialization of a potassium ion secondary battery, there is a demand for a material that can be used as a positive electrode active material, an electrolyte, a negative electrode active material, and the like of the potassium ion secondary battery.

An object of the present disclosure is to provide a novel negative electrode active material for a potassium ion secondary battery and a novel configuration of a potassium ion secondary battery.

### Solution to Problem

The present disclosure has found that the above problem can be achieved by the following means:
<Aspect 1>
   A negative electrode active material for a water-based potassium ion battery comprising tungsten oxide and/or comprising tungsten oxide.
<Aspect 2>
   An aqueous potassium ion secondary battery containing tungsten oxide as a negative electrode active material.
<Aspect 3>
   The aqueous potassium ion secondary battery according to aspect 2, wherein the aqueous potassium ion secondary battery comprising an aqueous electrolyte, wherein
   pH of the aqueous electrolyte is 4.0 to 12.0, and
   the aqueous electrolytic solution comprising a solvent comprising water and potassium pyrophosphate dissolved in the solvent.
<Aspect 4>
   The aqueous potassium ion secondary battery according to aspect 3, wherein the potassium pyrophosphate is dissolved in the solvent at a level of 2.0 mol or more per 1.0 kg of the solvent.
<Aspect 5>
   The aqueous potassium ion secondary battery according to aspect 3, wherein the potassium pyrophosphate is dissolved in the solvent at a level of 5.0 mol or more per 1.0 kg of the solvent.

### Advantageous Effects of Invention

According to the present disclosure, a novel negative electrode active material for a potassium ion secondary battery and a potassium ion secondary battery having a novel configuration can be provided.

### BRIEF DESCRIPTION OF DRAWINGS

FIG. 1 is a schematic diagram illustrating a potassium ion secondary battery 100 according to a first embodiment of the present disclosure.

FIG. 2 is a graph showing a charge-discharge curve of Example 1.

FIG. 3 is a graph showing a charge-discharge curve of Comparative Example 1.

FIG. 4 is a graph showing a charge-discharge curve of Comparative Example 2.

FIG. 5 is a graph showing a charge-discharge curve of Comparative Example 3.

FIG. 6 is a graph showing the relation between the concentration of potassium pyrophosphate and pH.

### DESCRIPTION OF EMBODIMENTS

Hereinafter, embodiments of the present disclosure will be described in detail. It should be noted that the present disclosure is not limited to the following embodiments, and the present disclosure can be variously modified within the scope of the present disclosure.

<Negative Electrode Active Material for Aqueous Potassium Ion Battery>

The negative electrode active material for the aqueous potassium ion battery of the present disclosure comprising tungsten oxide and/or consisting of tungsten oxide.

The present inventors have found that an aqueous potassium ion battery can be operated by using tungsten oxide as a negative electrode active material in combination with a predetermined aqueous electrolytic solution.

Tungsten oxide is also called tungsten trioxide. The tungsten oxide may be represented by the chemical formula WO₃₋ₓ. Here, 0≤x≤0.3, and may be x≤0.01, x≤0.05, x≤0.10, or x≤0.15. That is, the tungsten oxide may have a substantially maintained crystal structure of the tungsten trioxide. Thus, the tungsten oxide may be different from the chemical formula WO₃ generally representing tungsten trioxide, such as, for example, chemical formula WO_{2.7}, WO_{2.85}, WO_{2.90}, WO_{2.95}, or WO_{2.97}.

The shape of the tungsten oxide may be any general shape as the negative electrode active material of the battery. The tungsten oxide may be in particulate form, for example. The particle size in this case is not particularly limited, and an appropriate size may be selected according to the design of the battery. The tungsten oxide may have a primary particle diameter of 1 nm or more, 5 nm or more, 10 nm or more, or 50 nm or more, and may have a primary particle diameter of 500 μm or less, 100 μm or less, 50 μm or less, 30 μm or less, or 10 μm or less. In addition, the tungsten oxide may have primary particles aggregated to form secondary particles. The particle diameter of the secondary particles is not particularly limited, but may be, for example, 100 nm or more, 500 nm or more, or 1 μm or more, and may be 1000 μm or less, 500 μm or less, 100 μm or less, 50 μm or less, 30 μm or less, or 20 μm or less.

<Aqueous Potassium Ion Secondary Battery>

The aqueous potassium ion secondary battery of the present disclosure comprises tungsten oxide as a negative electrode active material.

The aqueous potassium ion secondary battery of the present disclosure may comprise an aqueous electrolyte solution. pH of the aqueous electrolyte can be from 4.0 to 12.0. The aqueous electrolyte may comprise a solvent comprising water and potassium pyrophosphate dissolved in the solvent.

That is, the potassium ion secondary battery of the present disclosure is a combination of a negative electrode active material and an aqueous electrolyte. The potassium ion secondary battery of the present disclosure has an aspect as a novel combination capable of charging and discharging a negative electrode active material.

Conventionally, almost no negative electrode active material is known which can be charged and discharged in an electrolyte solution in which a potassium compound is dissolved, regardless of whether it is a non-aqueous system or an aqueous system. Among the combinations of the electrolytic solution and the negative electrode active material, the optimum combination capable of charging and discharging is limited to a small part of the combinations of the electrolytic solution and the negative electrode active material which are infinitely present. If the crystal structure of the active material, the components of the electrolytic solution, the potential window, and the like change at least a little, charging and discharging cannot be performed as a potassium ion battery. That is, an optimum combination cannot be found unless the electrolyte solution and the negative electrode active material are actually combined and evaluated.

The technology of the present disclosure has found a novel combination capable of charging and discharging from an infinitely existing combination of an electrolyte solution and a negative electrode active material through a number of trials and errors. Therefore, the technology of the present disclosure is not easily conceivable from the prior art.

<Aqueous Electrolytic Solution>

pH of the aqueous electrolyte in the potassium-ion secondary batteries of the present disclosure is 4.0-12.0. In addition, the aqueous electrolyte solution comprises a solvent comprising water and potassium pyrophosphate dissolved in the solvent.

pH of the aqueous electrolyte solution may be 4.0 or more, 7.0 or more, 9.0 or more, or 10.0 or more, and may be 12.0 or less, 11.5 or less, 11.0 or less, or 10.5 or less.

(Solvent)

The solvent used in the potassium ion secondary battery of the present disclosure comprises water. The solvent may comprise water as a main component. That is, water may be 50 mol % or more, 70 mol %, 90 mol % or more or 95 mol % or more, based on the total amount of the solvent constituting the electrolyte (100 mol %). The upper limit of the ratio of water to the solvent is not particularly limited, and 100 mol percentage of the solvent, that is, the total amount of the solvent may be water.

The solvent may consist solely of water. In addition to water, the solvent may comprise further components, for example, one or more organic solvents selected from ethers, carbonates, nitriles, alcohols, ketones, amines, amides, sulfur compounds and hydrocarbons. A solvent other than water may be not more than 50 mol %, not more than 30 mol %, not more than 10 mol %, or not more than 5 mol %, based on the total amount of the solvent constituting the electrolyte (100 mol %).

(Potassium Pyrophosphate)

In the potassium ion secondary battery of the present disclosure, an aqueous electrolyte solution in which potassium pyrophosphate is dissolved is used as a solvent.

Here, the expression “the potassium pyrophosphate is dissolved” in the solvent means that the potassium ion and the pyrophosphate ion do not have to be completely ionized in the aqueous electrolyte solution. That is, in the aqueous electrolyte, the “dissolved potassium pyrophosphate” may be present as an ion such as K⁺, P₂O₇⁴⁻, KP₂O₇³⁻, K₂P₂O₇²⁻, K₃P₂O₇₋ or an aggregate of these ions. In addition, in the aqueous electrolyte solution, the “dissolved potassium pyrophosphate” may not be derived from a salt (K₄P₂O₇) of potassium and pyrophosphate (obtained by adding K₄P₂O₇ to water). For example, a solution in which a potassium ion source (such as KOH or CH₃COOK) and a pyrophosphate ion source (such as H₄P₂O₇) are separately added to water and dissolved, and as a consequence, the ion or the aggregate is formed in water is also included in the aqueous electrolyte solution.

The concentration of potassium pyrophosphate in the aqueous electrolytic solution is not particularly limited, and may be appropriately selected according to the performance of the purpose battery.

In the aqueous electrolyte solution, potassium pyrophosphate may be dissolved in water at a level of 2.0 mol or higher or 5.0 mol or higher per 1.0 kg of water.

According to the present inventor's new knowledge, as the concentration of potassium pyrophosphate in the aqueous electrolytic solution increases, the hysteresis of the positive electrode active material during charging and discharging becomes smaller, and high performance is easily obtained as a potassium ion secondary battery. In addition, as the concentration of potassium pyrophosphate in the aqueous electrolytic solution increases, the overvoltage decreases, and a good charge-discharge plateau is likely to be exhibited. Further, it is considered that the higher the concentration of potassium pyrophosphate in the aqueous electrolytic solution, the closer the pyrophosphate ion and the potassium ion are to each other, and the more easily the aggregate is formed. Therefore, for example, it is considered that the pyrophosphate ions are easily moved to the negative electrode side so as to be dragged by the potassium ions during charging of the potassium ion secondary battery. It is considered that pyrophosphate ions that reach the negative electrode decompose at a high work function site on the surface of the negative electrode, and a coating film is formed on the surface of the negative electrode. As a result, direct contact between the aqueous electrolyte and the high work function portion on the surface of the negative electrode is suppressed, and thus electrolysis of the aqueous electrolyte is easily suppressed.

The concentration of “dissolved potassium pyrophosphate” in the aqueous electrolyte can be specified as follows. For example, an element or an ion contained in the aqueous electrolyte solution is specified by elemental analysis or ion analysis. Next, the potassium ion concentration, the pyrophosphate ion concentration, and the like in the aqueous electrolyte solution are specified. Finally, the specified ion concentration is converted into the concentration of potassium pyrophosphate. Alternatively, the solvent is removed from the aqueous electrolyte and the solids are chemically analyzed to convert them to the concentration of potassium pyrophosphate.

In the aqueous electrolytic solution, the entire potassium ion comprised in the electrolytic solution may not be converted as “dissolved potassium pyrophosphate”. That is, more potassium ions than the concentration that can be converted as potassium pyrophosphate may be comprised in the aqueous electrolytic solution. For example, when an aqueous electrolytic solution is produced, when a potassium ion source other than a potassium pyrophosphate source (e.g., KOH or CH₃COOK or K₃PO₄) is added to water together with a potassium pyrophosphate source to dissolve the aqueous electrolytic solution, more potassium ions are comprised in the aqueous electrolytic solution than can be converted into potassium pyrophosphate.

The aqueous electrolyte solution may comprise cationics other than potassium ions. For example, the aqueous electrolyte may comprise alkali metal ions other than potassium ions, alkaline earth metal ions, transition metal ions, and the like. In addition, the aqueous electrolyte may comprise anions other than pyrophosphate ions (as described above, in addition to P₂O₇⁴⁻, they may be present in association with cationics, such as KP₂O₇³⁻, K₂P₂O₇²⁻, K₃P₂O₇⁻). For example, the aqueous electrolyte solution may comprise anions or the like derived from other electrolytes described later.

Other electrolytes may be dissolved in the aqueous electrolyte solution of the present disclosure. For example, a KPF₆, KBF₄, K₂SO₄, KNO₃, CH₃COOK, (CF₃SO₂)₂NK, KCF₃SO₃, (FSO₂)₂NK, K₂HPO₄, a KH₂PO₄, or the like may be dissolved in the aqueous electrolyte. Other electrolytes, the total amount of the electrolyte dissolved in the electrolyte solution as a standard (100 mol %), 50 mol % or less, 30 mol %, 10 mol % or less, 5 mol % or less or 1 mol % or less may be occupied.

(Other Ingredients)

In addition to the above-described solvents and electrolytes, the aqueous electrolyte may comprise an acid, a hydroxide, or the like for adjusting pH of the aqueous electrolyte, and various additives may also comprise the aqueous electrolyte.

<Other Configurations>

The potassium ion secondary battery of the present disclosure is not particularly limited as long as it has the above-described negative electrode active material and aqueous electrolyte solution. The potassium ion secondary battery of the present disclosure may be configured such that the negative electrode active material is in contact with the aqueous electrolyte solution.

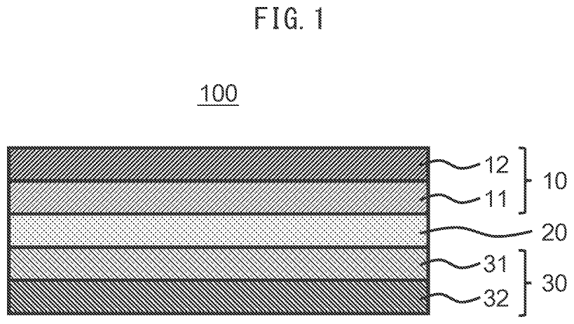

FIG. 1 schematically illustrates a configuration of a potassium ion secondary battery 100 according to a first embodiment of the present disclosure. As illustrated in FIG. 1, the potassium ion secondary battery 100 may include the positive electrode 10, the electrolyte layer 20, and the negative electrode 30. The positive electrode 10 may include the positive electrode active material layer 11 and the positive electrode current collector 12, and the negative electrode 30 may include the negative electrode active material layer 31 and the negative electrode current collector 32. In this case, the positive electrode active material layer 11 may include the above-described positive electrode active material. In addition, both of the positive electrode 10, the electrolyte layer 20, and the negative electrode 30 may include the above-described aqueous electrolyte solution.

(Positive Electrode)

The positive electrode may have a known configuration. For example, the positive electrode may include a positive electrode active material layer and a positive electrode current collector.

The positive electrode active material layer comprises a positive electrode active material, and may optionally comprise a conductive auxiliary agent, a binder, or the like. The thickness of the positive electrode active material layers is not particularly limited, but may be, for example, 0.1 μm or more or 1 μm or more, and may be 1 mm or less or 100 μm or less.

The positive electrode active material included in the positive electrode active material layer may be selected from active materials having a charge/discharge potential of carrier ions that is lower than that of the negative electrode active material, taking into consideration the potential window of the aqueous electrolyte solution and the like.

The positive electrode active material preferably comprises, for example, a K element. Specifically, the positive electrode active material is preferably an oxide comprising a K element, a polyanion, or the like. More specifically, potassium cobalt complex oxide (KCoO₂ and the like), potassium nickel complex oxide (KNiO₂ and the like), potassium nickel titanium complex oxide (KN_{1/2}Ti_{1/2}O₂ and the like), potassium nickel manganese complex oxide (KN_{1/2}Mn_{1/2}O₂, KNi_{1/3}Mn_{2/3}O₂ and the like), potassium manganese complex oxide (KMnO₂, KMn₂O₄ and the like), potassium iron manganese complex oxide (K_{2/3}Fe_{1/3}Mn_{2/3}O₂ and the like), potassium nickel cobalt manganese complex oxide (KNi_{1/3}Co_{1/3}Mn_{1/3}O₂ and the like), potassium iron complex oxide (KFeO₂ and the like), potassium chromium complex oxide (KCrO₂ and the like), potassium iron phosphate compound (KFePO₄ and the like), potassium manganese phosphate compound (KMnPO₄ and the like), potassium cobalt phosphate compound (KCoPO₄), Prussian blue, these solid solutions and non-stoichiometric compounds and the like can be exemplified as the positive electrode active material. Alternatively, potassium titanate, TiO₂, LiTi₂(PO₄)₃, sulfur (S), or the like can be used as the positive electrode active material.

Only one kind of the positive electrode active material may be used alone, or two or more kinds of the positive electrode active material may be used in combination.

The shape of the positive electrode active material is not particularly limited, and may be, for example, particulate. The particle size in this case is not particularly limited, and an appropriate size may be selected according to the design of the battery. The positive electrode active material may have a primary particle diameter of 1 nm or more, 5 nm or more, 10 nm or more, 50 nm or more, or 100 nm or more, and may have a primary particle diameter of 500 μm or less, 100 μm or less, 50 μm or less, 30 μm or less, or 10 μm or less. In addition, the positive electrode active material may have primary particles aggregated together to form secondary particles. The particle diameter of the secondary particles is not particularly limited, but may be, for example, 100 nm or more, 500 nm or more, or 1 μm or more, and may be 1000 μm or less, 500 μm or less, 100 μm or less, 50 μm or less, 30 μm or less, or 20 μm or less.

The amount of the positive electrode active material comprised in the positive electrode active material layer is not particularly limited. For example, the positive electrode active material may be 20 wt % or more, 40 wt % or more, may be 60 wt % or more or 70 wt %, 99 wt % or less, 97 wt % or less or 95 wt % or less in the entire positive electrode active material layer as a reference (100 wt %).

As the conductive auxiliary agent optionally comprised in the positive electrode active material layer, any known conductive auxiliary agent used in a potassium ion secondary battery can be employed. For example, a carbon material may be used as the conductive aid. Specifically, the conductive auxiliary agent is Ketjen Black (KB), Gas Phase Carbon Fiber (VGCF), Acetylene Black (AB), Carbon Nanotube (CNT), Carbon Nanotube (CNF), Carbon Black, Coke, Graphite, etc. Alternatively, the conductive aid may be a metallic material capable of withstanding the environment when the battery is in use. Only one kind of the conductive auxiliary agent may be used alone, or two or more kinds may be used in combination. As the shape of the conductive auxiliary agent, various shapes such as a powder shape and a fiber shape may be adopted. The amount of the conductive auxiliary agent comprised in the positive electrode active material layer is not particularly limited.

Any binder known as a binder used in a potassium ion secondary battery can be employed as the binder optionally comprised in the positive electrode active material layer. Examples of the binder include a styrene-butadiene rubber (SBR)-based binder, a carboxymethyl cellulose (CMC)-based binder, an acrylonitrile-butadiene rubber (ABR)-based binder, a butadiene rubber (BR)-based binder, a polyvinylidene fluoride (PVDF)-based binder, and a polytetrafluoroethylene (PTFE)-based binder. Only one binder may be used alone, or two or more binders may be used in combination. The amount of the binder comprised in the positive electrode active material layer is not particularly limited.

The positive electrode current collector may be made of a known metal or the like that can be used as a positive electrode current collector of a potassium ion secondary battery. Examples of such metals include metal materials comprising at least one element selected from the group consisting of Cu, Ni, V, and Au, Pt, Mg, Fe, Ti, Pb, Co, Cr, Zn, Ge, In, Sn, Zr. The form of the positive electrode current collector is not particularly limited. Various forms such as foil, mesh, porous, and the like may be employed. The metal may be deposited and plated on the surface of the substrate.

(Electrolyte Layer)

In the potassium ion secondary battery, for example, an electrolyte layer may be disposed between the positive electrode active material layer and the negative electrode active material layer. The electrolyte layer may be composed of a separator and the above-described aqueous electrolyte solution. As the separator, a separator well known as a separator used in a secondary battery (for example, a nickel-hydrogen battery, a zinc-air battery, or the like) can be employed. For example, the separator may have hydrophilicity such as a nonwoven fabric made of cellulose. The thickness of the separator is not particularly limited, and may be, for example, 5 μm or more and 1 mm or less.

(Negative Electrode)

The negative electrode may have a configuration known as a negative electrode of a potassium ion secondary battery. For example, the negative electrode may include a negative electrode active material layer and a negative electrode current collector.

The negative electrode active material layer comprises tungsten oxide as the negative electrode active material. In addition to the negative electrode active material, a conductive auxiliary agent or a binder may be included in the negative electrode active material layer. The thickness of the negative electrode active material layers is not particularly limited, but may be, for example, 0.1 μm or more or 1 μm or more, and may be 1 mm or less or 100 μm or less.

The type of the negative electrode active material comprised in the negative electrode active material layer is as described above. The amount of the negative electrode active material comprised in the negative electrode active material layer is not particularly limited. For example, the entire negative electrode active material layer as a reference (100 wt %), the negative electrode active material may be contained 20 wt % or more, 40 wt % or more, 60 wt % or more or 70 wt % or more, 99 wt % or less, 97 wt % or less or 95 wt % or less.

The type of the conductive auxiliary agent or the binder optionally comprised in the negative electrode active material layer is not particularly limited, and may be appropriately selected from those exemplified as the conductive auxiliary agent or the binder optionally comprised in the positive electrode active material layer. The amount of the conductive auxiliary agent or the binder comprised in the negative electrode active material layer is not particularly limited.

The negative electrode current collector may be composed of a known metal or the like that can be used as a negative electrode current collector of a potassium ion secondary battery. Examples of such metals include metal materials comprising at least one element selected from the group consisting of Cu, Ni, Al, V, and Au, Pt, Mg, Fe, Ti, Pb, Co, Cr, Zn, Ge, In, Sn, Zr. In particular, when considering the stability in an aqueous electrolyte solution or the like, the negative electrode current collector may include at least one element selected from the group consisting of Al, Ti, Pb, Zn, Sn, Mg, Zr and In, may include at least one element selected from the group consisting of Ti, Pb, Zn, Sn, Mg, Zr and In, and may include Ti. Both Al, Ti, Pb, Zn, Sn, Mg, Zr and In have a low work-function, and it is considered that electrolysis of the water-gas electrolyte is unlikely to occur even when they are contacted with the water-based electrolyte.

The form of the negative electrode current collector is not particularly limited. It can be in various forms, such as foil, mesh, porous, etc. The metal may be plated and deposited on the surface of the substrate.

The surface of the negative electrode current collector may be coated with a carbon material. That is, the negative electrode may further include a negative electrode current collector and a coating layer provided on a surface of the surface of the negative electrode current collector on which the aqueous electrolyte solution is disposed (between the negative electrode current collector and the negative electrode active material layer), and the coating layer may include a carbon material. Examples of the carbon material include Ketjen black (KB), vapor-phase carbon fiber (VGCF), acetylene black (AB), carbon nanotube (CNT), carbon nanofiber (CNF), carbon black, coke, and graphite.

The thickness of the coating layer is not particularly limited. In addition, a coating layer may be provided on the entire surface or a part of the surface of the negative electrode current collector.

A binder for binding the carbon materials and the carbon material to the negative electrode current collector may be comprised in the coating layer.

When a coating layer comprising a carbon material is provided on the surface of the negative electrode current collector, the withstand voltage on the reduction side of the aqueous electrolyte solution tends to be improved. Since the edge portion of the carbon material has a high reaction activity, adsorption and decompose of anions, for example, pyrophosphate ions, comprised in the aqueous electrolytic solution are likely to occur, and the coating film is likely to be deposited. Therefore, when the aqueous electrolyte solution is used in the potassium ion secondary battery, it is considered that the edge portion of the carbon material is deactivated and electrolysis of the aqueous electrolyte solution at the edge portion can be suppressed, and as a result, the reduction side potential window of the aqueous electrolyte solution is enlarged.

In addition to the above configuration, the potassium ion secondary battery may have an obvious configuration as a battery such as a terminal, a battery case, or the like.

The potassium ion secondary battery having the above configuration can be manufactured, for example, by forming a positive electrode active material layer in a dry or wet manner on the surface of a positive electrode current collector to obtain a positive electrode, forming a negative electrode active material layer in a dry or wet manner on the surface of a negative electrode current collector to obtain a negative electrode, disposing a separator between the positive electrode and the negative electrode, and impregnating these into an aqueous electrolyte solution.

### EXAMPLES

### Examples 1 and Comparative Examples 1 to 3

### Example 1

A negative electrode active material mixture was prepared by mixing tungsten oxide (WO₃) as a negative electrode active material, acetylene black as a conductive auxiliary agent, and PVDF and CMC as a binder in a weight ratio of 93:2:4.5:0.5. Using a doctor blade, the negative electrode active material mixture was uniformly coated on Ti foil, and dried to obtain a negative electrode for evaluation. That is, the negative electrode is formed by forming a negative electrode active material layer including a negative electrode active material or the like on a surface of a Ti foil as a negative electrode current collector.

(Preparation of Evaluation Cell)

An evaluation cell having the following configuration was manufactured.
Cell: VM2 (manufactured by Easy Frontier)
Working electrode: The above negative electrode, opening area 1 cm²
Counter electrode: Pt mesh
Reference pole: Ag/AgCl
Aqueous electrolyte: an aqueous solution of 5.0 mol/kg potassium pyrophosphate (K₄P₃O₇)

(Evaluation of Cells)

The evaluation cells were charged and discharged under the following conditions to evaluate the charge and discharge characteristics.
Charge/discharge current: 0.2 mA/cm²
   Cut-off voltage: −0.90˜0.50V vs. Ag/AgCl
   Number of cycles: 20
   Temperature: 25° C.

### Comparative Examples 1 to 3

The tests of Comparative Examples 1 to 3 were carried out in the same manner as in Example 1, except that the aqueous electrolyte solution was sequentially used as K₂SO₄ of Na₂SO₄ and 0.5 mol/kg of LiTFSI, 2.0 mol/kg of 5.0 mol/kg.

Results

Table 1 shows the type and concentration of the electrolyte used in each case, the half-wave potential (V vs. Ag/AgCl) at the time of charging and discharging, and the reactive ionic species.

TABLE 1

| | | | Results | |
|---|---|---|---|---|
| | | | Half-wave | Reactive |
| | Conditions | Density | potential (V | ionic |
| Examples | Electrolyte | (mol/kg) | vs. Ag/AgCl) | species |
| Example 1 | K₄P₃O₇ | 5.0 | −0.611 | K⁺ |
| Comparative | LiTFSI | 5.0 | −0.358 | H⁺ |
| Example 1 | | | | |
| Comparative | Na₂SO₄ | 2.0 | −0.291 | H⁺ |
| Example 2 | | | | |
| Comparative | K₂SO₄ | 0.5 | −0.246 | H⁺ |
| Example 3 | | | | |

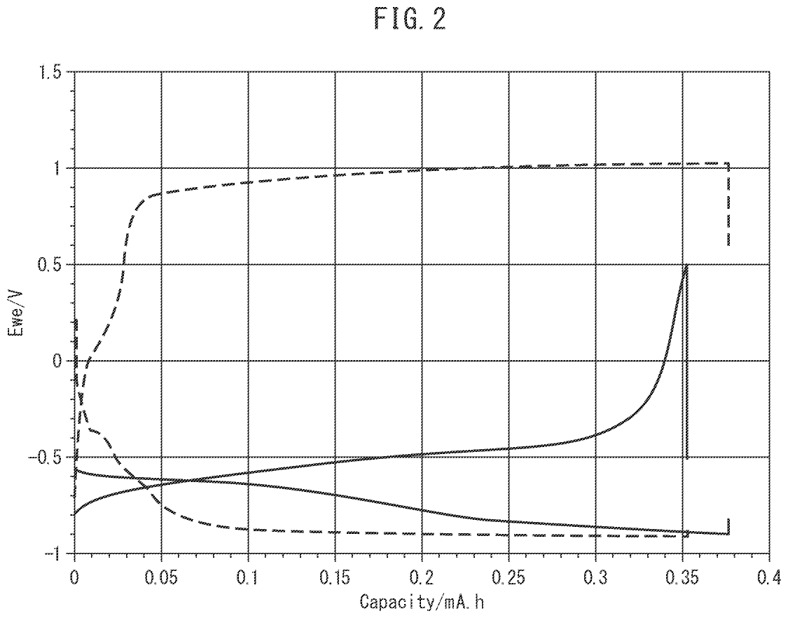

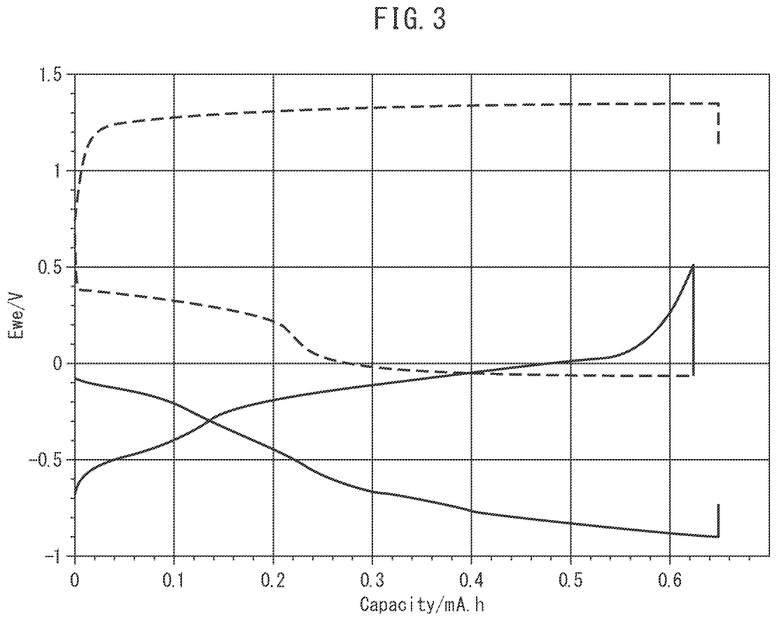

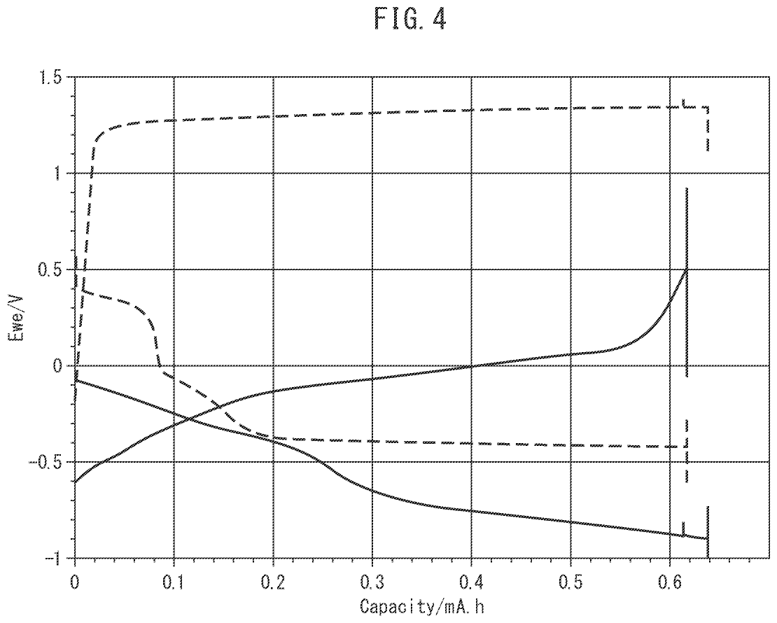

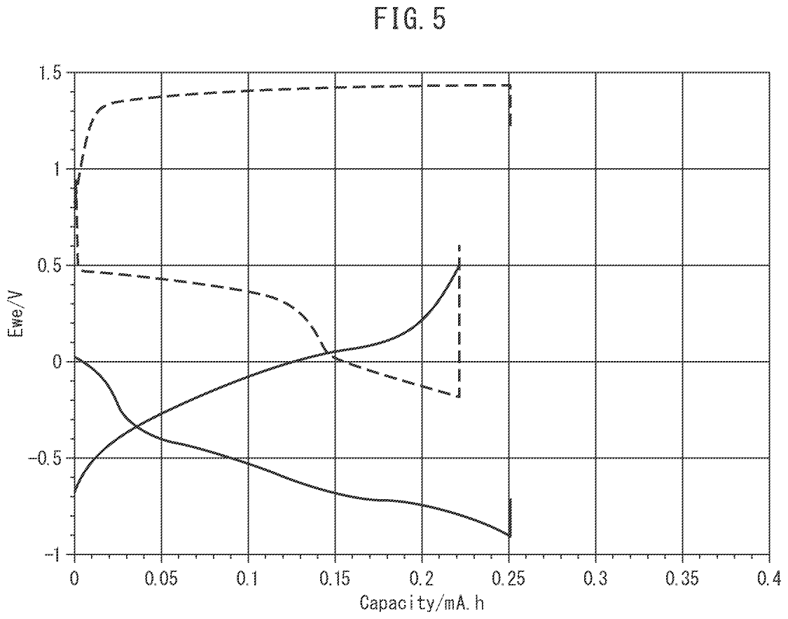

FIG. 2 to FIG. 5 show the charging and discharging results of the respective examples. In FIGS. 2 to 5, the solid line indicates the charge/discharge reaction of tungsten oxide, and the broken line indicates the redox/decomposition reaction at Pt counter electrode.

As shown in Tables 1 and 2 to 5, in Comparative Examples 1 to 3 using LiTFSI, K₂SO₄, and Na₂SO₄, the reduction potential of the counter electrode is more noble than the reduction potential of the working electrode. Therefore, the reaction potential of WO₃ is generally lower than the potential of the liquid decomposition, and therefore, the reaction should be disabled. Therefore, in these examples, the reduction current on the opposite electrode side is due to the hydrogen generation reaction by electrolysis of water.

On the other hand, since the potential of the solution decomposition is lower than the charge potential of WO₃ in EXAMPLE 1 in which 5.0 mol/kg aqueous K₄P₂O₇ solution is used as the negative electrode active material, since the reduction potential of the counter electrode is lower than the reduction potential of the working electrode, the negative electrode active material generally behaves.

In Example 1, the half-wave potential was about 0.3V vs. Ag/AgCl lower than in Comparative Examples 1-3. This shows that, unlike Comparative Examples 1-3, the reactive ionic species are K⁺ in Example 1.

### Reference Example

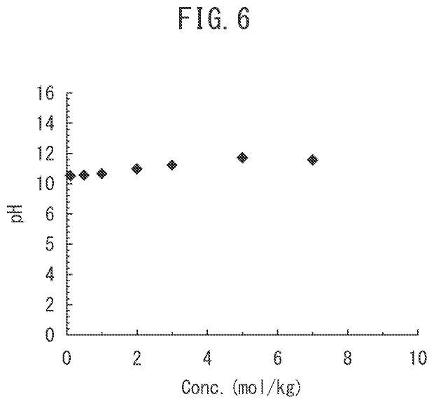

The relation between the concentration of the aqueous potassium pyrophosphate solution and pH is shown in FIG. 6.

pH of the aqueous potassium pyrophosphate solution was 10.0-12.0 when the concentration of potassium pyrophosphate in the aqueous solution of potassium pyrophosphate was below 0 mol/kg super 8 mol/kg.

### REFERENCE SIGNS LIST

10 Positive electrode
11 Positive electrode active material layer
12 Cathode current collector
20 Electrolyte layer
30 Negative electrode
31 Negative electrode active material layer
32 Anode current collector
100 Potassium ion secondary battery

1. A negative electrode active material for a water-based potassium ion battery comprising tungsten oxide/or consisting of tungsten oxide.

2. An aqueous potassium ion secondary battery comprising tungsten oxide as a negative electrode active material.

3. The aqueous potassium ion secondary battery according to claim 2, wherein the aqueous potassium ion secondary battery comprising an aqueous electrolyte, wherein
pH of the aqueous electrolyte is 4.0 to 12.0, and
the aqueous electrolyte contains a solvent comprising water and potassium pyrophosphate dissolved in the solvent.

4. The aqueous potassium ion secondary battery according to claim 3, wherein the potassium pyrophosphate is dissolved in the solvent at a level of 2.0 mol or higher per 1.0 kg of the solvent.

5. The aqueous potassium ion secondary battery according to claim 3, wherein the potassium pyrophosphate is dissolved in the solvent at a level of 5.0 mol or higher per 1.0 kg of the solvent.
